(19) United States
(12) Patent Application Publication
(10) Pub. No.: US 2008/0116739 A1
(43) Pub. Date: May 22, 2008

(54) Adaptive Antiskid Means for Rail Vehicles with a Slip Controller

(75) Inventors: Wolfram Lang, Erlangen (DE); Wolfgang Rulka, Munchen (DE); Thorsten Stutzle, Aachen (DE); Anton Stribersky, Eberschwang (AT); Uwe Viereck, Aachen (DE)

Correspondence Address: LERNER GREENBERG STEMER LLP, P O BOX 2480, HOLLYWOOD, FL, 33022-2480, US

(73) Assignee: SIEMENS TRANSPORTATION SYSTEMS GMBH & CO. KG, Wien (AT)

(21) Appl. No.: 11/913,009

(22) PCT Filed: Apr. 18, 2006
(86) PCT No.: PCT/AT06/00155

§ 371 Date: Nov. 15, 2007

(30) Foreign Application Priority Data
Apr. 28, 2005 (AT) A 733/2005

(51) Int. Cl. B60T 8/172

(52) U.S. Cl. 303/15

(57) ABSTRACT

The invention relates to a method for adapting the brake cylinder pressure (pc,_{actual}; pc₁/pc₂/pc₃/pc₄) of a pneumatic brake of a rail vehicle (FZG). According to the invention, during a braking process, the momentary actual slip (s_{actual}) between at least one wheel (2) of the rail vehicle (FZG) and a rail (3) is determined, a desired slip (s_{desired}) between the at least one wheel (2) and the rail (3) is predetermined, and the brake cylinder pressure (pc,_{actual}; pc₁, pc₂/pc₃, pc₄), which corresponds to the difference of the actual slip (s_{actual}) from the predetermined actual slip (s_{desired}), is modified such that the difference between the desired and actual slip is approximately zero or is at a minimum. The desired slip can be, selectively, in the micro or macro slip range. A braking state factor is determined in the event of a stable braking process, from axle speed measurements and brake cylinder pressures.

The invention relates to a method for adapting the brake cylinder pressure of a pneumatic brake of a rail vehicle.

The invention further relates to a slip controller for a rail vehicle for adapting the current slip to a predefined setpoint slip.

Furthermore, the invention also relates to a control system comprising such a slip controller.

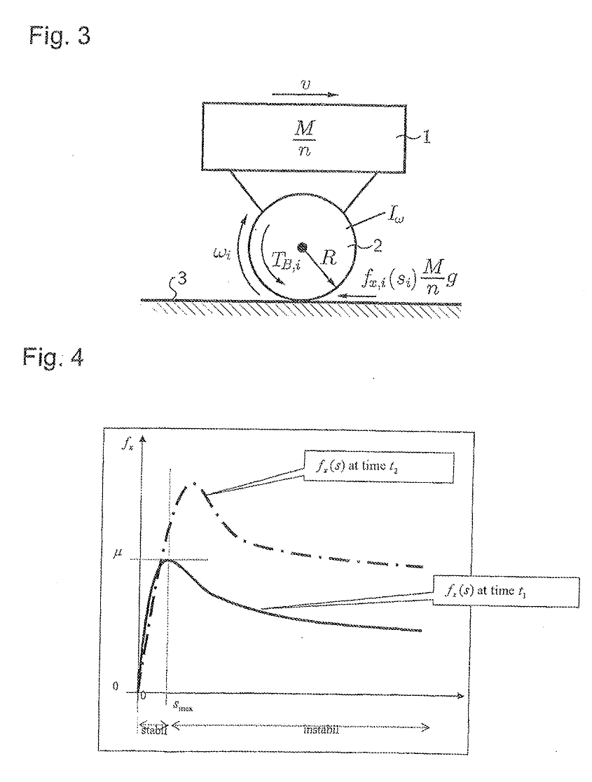

The need for antiskid means in rail vehicles results from the risk of an axle suddenly and undesirably coming to a stop when a rail vehicle is being braked. In order to initiate the braking process, in pneumatic brake systems, a brake control pressure is applied to the pneumatic brake cylinders on each wheel axle. The braking torque T_{B} which is applied in this way brings about a negative angular acceleration of the wheels. This produces on the wheel contact faces a relative speed Δν between the wheel and rail and thus a frictional force which is dependent on the relative speed Δν and which decelerates the vehicle. The force and torque conditions in a braking process are illustrated schematically in FIG. 3. Here, the relationships with the relative speed which is standardized to the velocity ν, what is referred to as the slip s=Δν/ν, are illustrated.

The frictional force is the product of the adhesion loading fₓ, which is nonlinearly dependent on the slip, and the wheel contact force, as illustrated in FIG. 4. As the slip s increases, the adhesion loading fₓ rises quickly, and drops away slowly after its maximum value has been reached. The maximum value μ of the adhesion loading is greatest in the case of a dry rail and decreases significantly when the weather conditions become poor. If the braking process takes place on the rising branch of an fₓ slip curve, it is stable. If an excessively high slip value exceeds the maximum value, the controlled system becomes unstable and the wheel decelerates very quickly and becomes stationary. In this context, a prolonged braking distance and an undesired flat point on the wheel occur.

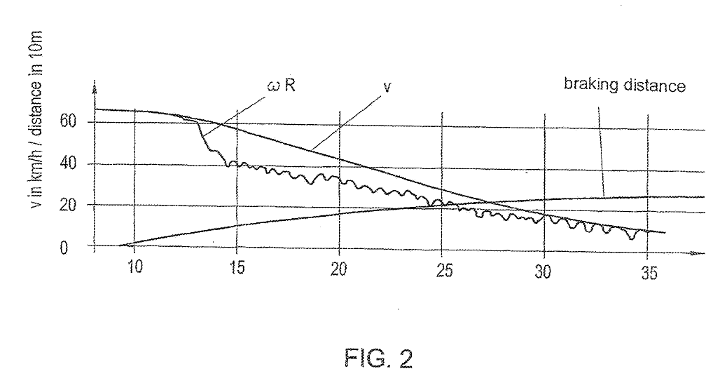

The region to the left of the maximum value in FIG. 2 is also referred to as “microslip”, and the region to the right of the maximum value is also referred to as “macroslip”.

Modern antiskid systems are intended, on the one hand, to prevent the axle coming to a standstill and, on the other hand, to bring about a high level of utilization of adhesion in the contact between the wheel and the rail (and thus a braking distance which is as short as possible) under various weather conditions.

Commercially available antiskid systems according to the prior art use knowledge-based controllers which assess the current state by means of a suitable evaluation of measurement variables, obtain the suitable reaction from a decision table and implement it as a series of pulses to the antiskid valves. For each rail vehicle series, individual adaptation of the large number of controller parameters is necessary, and said adaptation can be carried out only by antiskid experts with specialist knowledge and experience. The necessary test runs are very time consuming and expensive.

An object of the invention is to develop an antiskid means in pneumatic brakes for rail vehicles which is significantly easier to construct and to set than the antiskid means known from the prior art, which makes it possible to reduce the costs and time involved in the setting. The braking distances which are achieved are intended here to be at least as short as the braking distances achieved with “conventional” systems. At least the braking distance values which are predefined by regulations are to be complied with.

This object is achieved with a method mentioned at the beginning in that according to the invention during a braking process the instantaneous actual slip between at least one wheel of the rail vehicle and a rail is determined, and furthermore a setpoint slip between the at least one wheel and the rail is predefined, and the brake cylinder pressure is varied in accordance with the deviation of the actual slip from the predefined setpoint slip in such a way that the deviation between the setpoint slip and the actual slip approaches zero or is minimized.

In this way it is significantly easier to change the brake cylinder pressure for a braking process than is known from the prior art, and no further settings, or only small additional settings, are necessary on the control system.

In principle, the method according to the invention functions satisfactorily if a permanently set value is predefined for the setpoint slip. The method can, however, also be improved significantly if the value for the setpoint slip can be predefined in a variable fashion, and continuous adaptation of the setpoint slip to the current conditions is thus possible. The method functions in an optimum way if the setpoint slip is determined within the scope of an optimum slip search.

The setpoint slip can be selected in the region of the microslip but also in the region of the macroslip, as will be explained in more detail later.

It is expedient if the actual slip is measured continuously during the entire braking process. However, as a rule the slip control requires continuous measurement of the actual slip during the entire braking process.

As is also explained in more detail below, in one specific embodiment of the invention it is favorable if the actual brake cylinder pressure is additionally measured, a setpoint brake cylinder pressure is also determined with reference to the deviation of the actual slip from the predefined setpoint slip, and the actual brake cylinder pressure is varied in such a way that the deviation between the setpoint slip and the actual slip approaches zero or is minimized.

In order easily to permit adaptation of the inventive control of the brake cylinder pressure to different types of vehicle and models of vehicle, the invention also relates to a method for adapting the transmission factor K_{R} of a slip controller as a function of at least one vehicle-specific parameter. For this purpose, during a stable braking process on an essentially level and straight rail, the axle speed ω and the brake cylinder pressure p_{c} of a wheel set with the rolling radius R are continuously measured, and the vehicle-specific parameter, referred to as the brake state factor ζ, is determined therefrom in accordance with the following relationship:

$$ξ = - \frac{R {\dot{ω}}_{i}}{Pc , i} .$$

The adaptation of the controller transmission factor can be carried out very easily with a further method, described below within the scope of this invention, for adapting the transmission factor K_{R} of an antiskid controller. A stable test braking process is sufficient to determine the brake state factor. This constitutes a significant advantage over the adaptation of knowledge-based controllers in which a large number of different entries from a large table have to be newly determined by means of a plurality of test runs.

In order to achieve optimum adaptation, there is provision for the measured values of a stable braking process to be used exclusively.

Furthermore, it is favorable if the axle speeds are measured at q axles and the brake cylinder pressures are measured at l axles, whereby the following relationship can be used to determine the brake state factor (ξ)

$$ξ = - R \frac{\frac{1}{q} {\sum }_{i = 1}^{q} {\dot{ω}}_{i}}{\frac{1}{l} {\sum }_{i = 1}^{l} {p}_{C , i}} .$$

In this way it is possible to minimize falsifications of the conversion from the wheel rotation to the velocity by virtue of the fact that the mean value over all the axles of the rail vehicle is used in the implemented identification equation.

In a specific embodiment, at m different times, measured values are recorded, the brake state factors ξ(k) associated with the times are determined, and mean values are formed for the brake state factors ξ(k):

$$\overline{ξ} = \frac{1}{m} {\sum }_{k = 1}^{m} ξ ( k ) .$$

Adaptation of the transmission factor (K_{R,i}) of a slip controller (SRE) from a reference vehicle to another vehicle is calculated using the brake state factor in accordance with the relationship

$${K}_{R , i} = {K}_{R , i}^{′} \frac{{ξ}^{′}}{ξ} ,$$

where K′_{R,i} is the known controller transmission factor of a reference vehicle, and ξ′ is the brake state factor of the reference vehicle.

The adaptation of the brake state factor can also be refined if the following relationship is used when a current measured value for the total vehicle mass is present:

$${K}_{R , i} = {K}_{R , i}^{′} \frac{{ξ}^{′}}{ξ} \frac{M}{{M}_{0}} ,$$

where M is the current rail vehicle mass and M₀ is the mass which the rail vehicle has during the determination of the brake state factor ξ.

The invention will be explained in more detail below with reference to the drawing, in which:

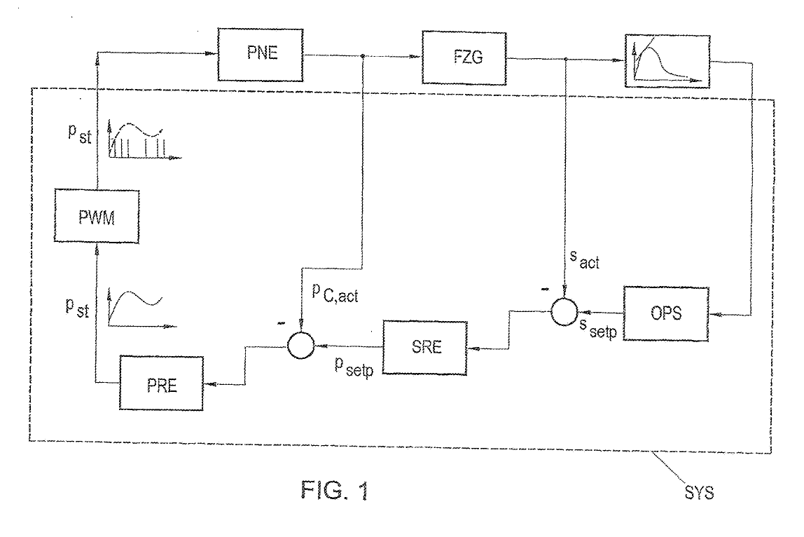

FIG. 1 is a schematic illustration of a control system according to the invention,

FIG. 2 shows the schematic profile of the velocity of a rail vehicle and of other relevant variables during a braking process,

FIG. 3 is a schematic illustration of the force and torque relationships in an n-th vehicle model,

FIG. 4 shows the nonlinear profile of a typical schematic adhesion loading setup curve at the start of braking and during the braking, caused by conditioning effects,

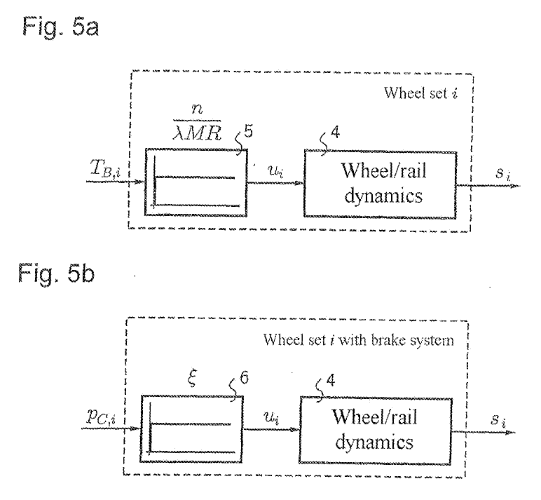

FIGS. 5a and 5b show functional diagrams explaining the structure of the controlled system,

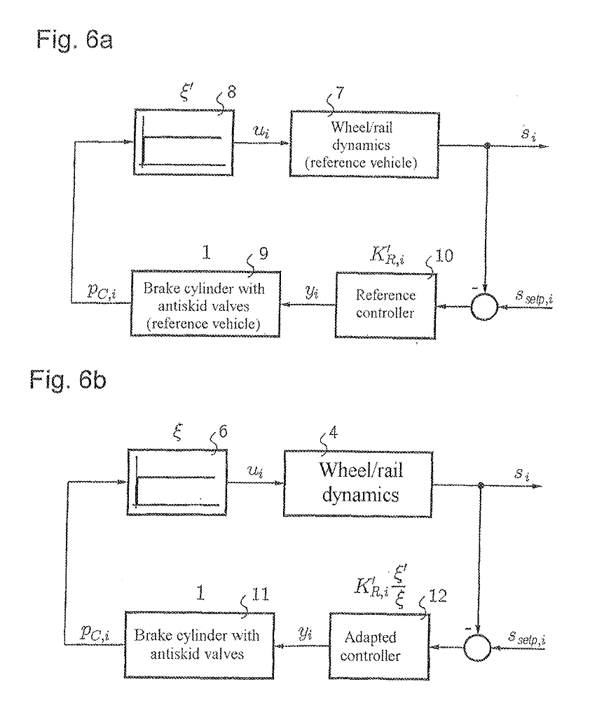

FIGS. 6a and 6b show functional diagrams explaining the adaptation of the controller transmission factor by means of the brake state factor,

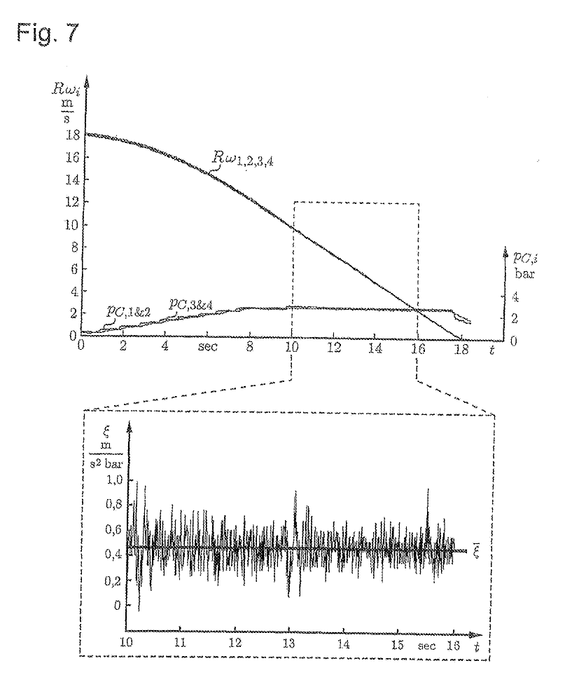

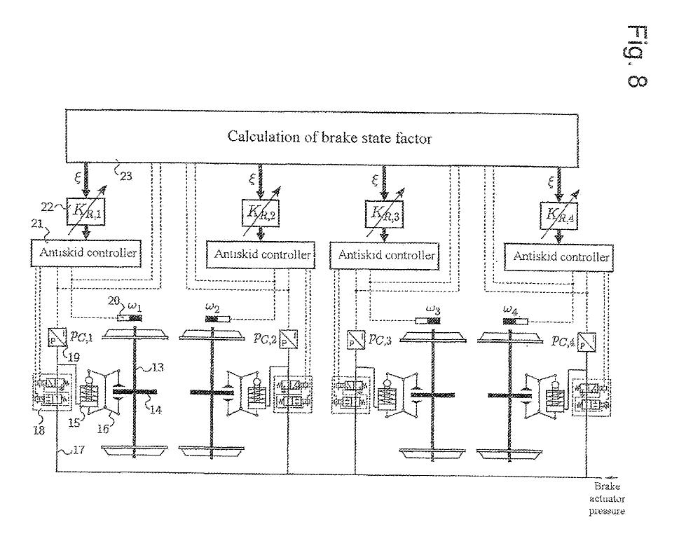

FIG. 7 shows measured values of the wheel speeds and brake cylinder pressures of a real rail vehicle and the brake state factors calculated therefrom, and

FIG. 8 shows an exemplary embodiment of the implementation of the method for adapting the transmission factor of an antiskid controller.

The following designations are used for the following explanations:

| | |
|---|---|
| A_{K} | brake cylinder piston face |
| fₓ | adhesion loading |
| g | acceleration of the earth |
| I_{ω} | moment of inertia of the wheel set |
| k | numerical variable for measuring times |
| K_{R} | controller transmission factor |
| l | number of wheel sets with measurement of brake cylinder |
| | pressure |
| m | number of measuring times |
| M | total mass of the rail vehicle |
| M₀ | total mass of the rail vehicle at the time of the |
| | braking process |
| n | number of wheel sets |
| n_{z} | number of brake cylinders per axle |
| p_{c} | brake cylinder pressure |
| q | number of wheel sets with measurement of axle speed |
| rₘ | central frictional radius |
| R | wheel radius |
| s | slip |
| T_{B} | braking torque |
| u | input variable of the “wheel/rail dynamics” system |
| ü_{G} | total linkage transmission ratio |
| ν | velocity of the vehicle |
| v_{G} | skidding speed |
| y | manipulated variable of the controller |
| η_{G} | linkage efficiency |
| λ | rotation factor |
| μ | maximum adhesion loading |
| μ_{B} | mean coefficient of friction of brake lining |
| ξ | brake state factor |
| π | relationship between controller manipulated variable |
| | and brake cylinder pressure |
| ρ | control algorithm without controller transmission |
| | factor |
| ω | axle speed |

Indices such as “i” designate the numerical variable for the wheel sets and “setp” stands for the guide variable. The superscripted sign “′” denotes the reference controller.

FIG. 1 is a schematic view of a control system SYS according to the invention for the inventive control of the brake cylinder pressure p_{c,act} of a pneumatic brake PNE (see also FIG. 8 with the brake cylinder pressures p_{c,1}, p_{c,2}, p_{c,3}, p_{c,4}).

During a braking process, the instantaneous actual slip s_{act} between at least one wheel 2 of the rail vehicle and a rail 3 is determined at the rail vehicle FZG (see also FIG. 3) and is available as a signal which is continuous over time. Furthermore, a setpoint slip sₛₑₜₚ is predefined between the wheel 2 and the rail 3.

Depending on the deviation of the actual slip s_{act} from the predefined setpoint slip sₛₑₜₚ, the brake cylinder pressure p_{c,act}, and thus the braking torque, are varied in such a way that the deviation between the setpoint slip and actual slip approaches zero or is minimized taking into account the faults in the real system.

A continuous cascade controller forms the core of the control system SYS according to the invention. The slip control SRE which is described above and which operates according to a PIDT method (linear controller) is central and it determines a brake cylinder setpoint pressure pₛₑₜₚ in accordance with the predefined setpoint slip sₛₑₜₚ and the current actual slip s_{act}. In the subordinate pressure controller PRE of the control system SYS, the brake control pressure signal pₛₜ, which corresponds, for example, to the necessary change in the cylinder pressure, is determined from the difference between this brake cylinder setpoint pressure pₛₑₜₚ and the measured cylinder pressure p_{c,act}. If necessary, a downstream switching sequence generator module PWM converts the continuous pressure control signal pₛₜ into a pulse width-modulated discrete signal for actuating the antiskid valves. The pulsed signal can only assume the values “0” or “1”, which is interpreted by the pneumatic valves as “open” or “closed”.

The setpoint slip sₛₑₜₚ can be predefined in a fixed fashion, but preferably different values for the setpoint slip sₛₑₜₚ are set during the braking process. In particular, it is favorable if the setpoint slip sₛₑₜₚ is determined by a corresponding optimum slip searcher OPS, which is superimposed on the actual slip controller, and also has the rotational speed ωᵢ of the wheel set i as an input, see FIG. 1. A procedure for determining the optimum slip is known, for example, from: U. Kiencke, Realtime Estimation of Adhesion Characteristic between Tyres and Road, Proceedings of the IFAC World Congress, vol. 1, pp. 15-18, Sydney, July 1993.

The control system SYS according to the invention is therefore composed essentially of a continuous cascade controller with the central linear slip controller SRE, a pressure control circuit PRE which can be optionally connected into the circuit, and a superimposed setpoint value predefining means and an optionally superimposed optimum slip searcher OPS (optimum slip is that slip at which the best possible utilization of adhesion occurs) and a downstream switching sequence generator. Input variables of this control system SYS are the current rotational speed of the axle ω and the velocity ν for determining the slip s_{act}. The output variable is the brake control pressure signal pₛₜ. In general, the brake control pressure signal pₛₜ is generated as a pulsed pattern, due to pneumatic valves which are already present.

As is also apparent from FIG. 8, such a control system is usually provided for the brake or brakes on each axle of a rail vehicle. In principle, it would, however, also be conceivable for a control system to be provided for a plurality of axles or the brake or brakes of a plurality of axles.

The subordinate pressure control allows the brake cylinder pressure to be kept more precisely at the setpoint pressure, which minimizes the number of wheel debraking operations and thus leads to a low consumption of air and to short braking distances, but pneumatic valves with cylinder pressure sensors are required.

FIG. 2 shows by way of example a braking process of a rail vehicle using an inventive slip controller SRE or control system SYS. The velocity v of the vehicle, the circumferential speed ωR of the wheel and the braking distance BWE are represented. As is clearly apparent, the circumferential speed ωR of the wheel decreases to a greater extent than the velocity of the vehicle v at the beginning. In order to prevent the wheel being braked to a speed of zero (undesired skidding), the brake pressure is correspondingly reduced so that the circumferential speed of the wheel can increase again. The brake pressure can then be increased again etc.

As is clearly apparent, it is particularly important, in particular at low speeds, that is to say near to the stationary state of the vehicle, for the brake pressure to be controlled very precisely in order to prevent the wheels from skidding. Correspondingly, in this range the circumferential speed of the wheels is kept close to the velocity of the vehicle.

FIG. 4 shows the nonlinear profile of the adhesion loading slip curve. The frictional force is the product of the adhesion loading fₓ which is dependent in a nonlinear fashion on the slip, as illustrated in FIG. 4, and the wheel contact force. As the slip s increases, the adhesion loading fₓ rises quickly and drops slowly after reaching its maximum value. The maximum value μ of the adhesion loading is greatest in the case of a dry rail and decreases significantly if the weather conditions become poor. If the braking process takes place on the rising branch of an fₓ slip curve, it is stable. When the maximum value is exceeded by an excessively high slip value, the controlled system becomes unstable and the wheel decelerates very quickly and becomes stationary.

If the braking process takes place to the left of the maximum value (“microslip”, s<sₘₐₓ), the wheel remains stable. In the case of braking processes to the right of the maximum value (“macroslip”, s>sₘₐₓ), the wheel becomes basically unstable, i.e. it decelerates very quickly and finally becomes stationary while at the same time the inert mass of the rail vehicle continues moving with a velocity greater than zero. This results in the formation of a flat point.

During a braking process, a change in the behavior of the material occurs as a result of the relative velocity Av and the frictional forces or heat caused thereby. Furthermore, the leading wheels clean the rail for the trailing axles. This behavior is referred to as a conditioning effect and results in the level of the adhesion curve rising during a braking process, as illustrated in FIG. 4 (unbroken line at a time t₁ “before” the occurrence, and dot-dashed line for fₓ at a time t₂ “after” the occurrence of conditioning effects).

The control system SYS according to the invention operates in a stable fashion in the macro- and microslip regions without the braking process becoming unstable and without the wheel becoming stationary.

Operation in the microslip region provides a number of advantages, such as a very low-wear braking process which is associated with a high level of comfort (few activations of valves). However, extremely precise measurements of the input variables are necessary as a result of the steeply rising curve in this region.

Such precise measurement of the input variables is not necessary for the macroslip control, in particular in the flat part of the characteristic curves. Furthermore, as a result of the high slip values the abovementioned conditioning effects are activated and they significantly increase the values for the adhesion loading fₓ during braking. Significantly higher braking forces can thus be transmitted, and the braking distances are therefore shortened.

In driving trials it was possible to detect a relatively low air consumption of the pneumatic brake and significantly better braking performance with the control according to the invention compared to a conventional antiskid system.

In the text which follows, more details will be given on the basic principles on which the invention is based, and further advantageous aspects of the invention will be examined in more detail.

As already mentioned, instead of a characteristic diagram controller, as known from the prior art, a conventional controller SRE is advantageously used with the slip s or the relative velocity Δν (difference between the absolute speeds of the vehicle and of the wheel) as a controlled variable.

The object of keeping the expenditure on adjustment for various vehicle types low is achieved by means of two strategies. On the one hand, the time constants of the control device and of the signal filtering are determined by means of a robust controller design in such a way that the antiskid means operates in a stable fashion for a wide range of vehicle types extending from a locomotive to the Metro. A few parameters such as the vehicle mass, the time constant of the pneumatics and the transmission factor K′_{R} of the controller are adaptive, i.e. vehicle-specific parameters of the control algorithm. These parameters are determined during commissioning or from measured variables of selective test braking maneuvers.

The test braking maneuver is carried out with the rail vehicle on a level and straight section of track, and it is imperative that none of the axles becomes unstable during the braking process owing to the prevailing weather conditions. For the duration of the braking process, the axle decelerations ωᵢ and the brake cylinder pressures (C pressures) p_{c,i} are measured continuously. The static transmission factor ξ between the brake cylinder pressure and vehicle deceleration can be determined from the measured values when the wheel radius R is known. The transmission factor ξ′ which is referred to below as the brake state factor, is composed of all the relevant parameters of the brake system and of the vehicle. If there is a conventional controller with the transmission factor K′_{R} for a rail vehicle with the brake state factor ξ′, the transmission factor of the same controller can be adapted for another rail vehicle with the brake state factor ξ by means of the relationship

$${K}_{R} = {K}_{R}^{′} \frac{{ξ}^{′}}{ξ} . \qquad ( 1 )$$

With a further method which is described as follows within the scope of this invention, for adapting the transmission factor of an antiskid controller, the adaptation of the controller transmission factor can be carried out very easily because a stable braking process is sufficient to determine the brake state factor. This constitutes a significant advantage over the adaptation of knowledge-based controllers, in which a large number of different entries from a large table have to be newly determined by means of a plurality of trial runs.

FIG. 3 shows the force and torque conditions in an n-th vehicle model. The n-th part of the rail vehicle body 1 is connected to the braked wheel 2 of the axle i, which wheel 2 moves on the rail 3. If the law of the conservation of momentum and angular momentum is applied to the model shown, the equations (2) and (3) are obtained.

Formulating the movement equations for the n-th vehicle model of a vehicle with n axles supplies:

$$\begin{matrix}\dot{v} = \frac{n}{m} [ - ( \frac{1}{n} {\sum }_{i = 1}^{n} {f}_{x , i} ( {s}_{i} ) ) \frac{M}{n} g ] = - g \frac{1}{n} {\sum }_{i = 1}^{n} {f}_{x , i} ( {s}_{i} ) & ( 2 ) \\ \begin{matrix}{\dot{ω}}_{i} = \frac{1}{{I}_{ω}} [ {Rf}_{x , i} ( {s}_{i} ) \frac{M}{n} g - {T}_{B , i} ] & I = 1 , … , n\end{matrix} & ( 3 )\end{matrix}$$

The velocity ν of the vehicle and the axle speed of the i-th axle ωᵢ are combined with one another by means of the nonlinear slip relationship:

$${s}_{i} = \frac{\frac{v}{R} - {ω}_{i}}{\frac{v}{R}} . \qquad ( 4 )$$

Deriving the equation (4) over time produces

$${\dot{s}}_{i} = \frac{1}{v} [ \dot{v} ( 1 - {s}_{i} ) - R {\dot{ω}}_{i} ] . \qquad ( 5 )$$

Inserting equations (2) and (3) into (5) supplies

$${\dot{s}}_{i} = \frac{1}{v} [ g ( ( {s}_{i} - 1 ) ( \frac{1}{n} {\sum }_{i = 1}^{n} {f}_{x , i} ( {s}_{i} ) ) - \frac{{R}^{2} M}{{I}_{ω} n} {f}_{x , i} ( {s}_{i} ) ) + \frac{R}{{I}_{ω}} {T}_{B , i} ] . \qquad ( 6 )$$

A nonlinear differential equation is therefore found for the dynamic behavior of the slip. With the rotation factor λ which is customary in rail vehicle technology and for which the following applies

$$λ = 1 + \frac{{I}_{ω} n}{{MR}^{2}} \qquad ( 7 )$$

in the n-th vehicle model,
equation (6) becomes

$${\dot{s}}_{i} = \frac{1}{v} [ g ( ( {s}_{i} - 1 ) ( \frac{1}{n} {\sum }_{i = 1}^{n} {f}_{x , i} ( {s}_{i} ) ) - \frac{1}{λ - 1} {f}_{x , i} ( {s}_{i} ) ) + \frac{λ}{λ - 1} {u}_{i} ] . \qquad ( 8 )$$

The variable uᵢ which is newly introduced into equation (8) is the input variable of a system described by the equations (2) and (8) and which represents the wheel/rail dynamics. From comparison of equation (8) with (6) the following is obtained

$${u}_{i} = \frac{n}{λ MR} {T}_{B , i} . \qquad ( 9 )$$

In a pneumatic brake system, the braking torque of the i-th axle with respect to the operating point is typically

T_{B,i}=rₘμ_{B}η_{G}ü_{G}n_{Z}A_{K}p_{c,l}. (10)

Inserting equation (10) into equation (9) provides a relationship between uᵢ and the brake cylinder pressure p_{c,i}

$${u}_{i} = \frac{n}{λ MR} {r}_{m} {μ}_{B} {η}_{G} {\ddot{u}}_{G} {n}_{Z} {A}_{K} {p}_{C , i} . \qquad ( 11 )$$

The vehicle-specific parameters which occur in equation (11) are combined to form the so-called brake state factor ξ:

$$ξ = \frac{n}{λ MR} {r}_{m} {μ}_{B} {η}_{G} {\ddot{u}}_{G} {n}_{Z} {A}_{K} . \qquad ( 12 )$$

It is shown below that the brake state factor ξ can be determined from measured values of the wheel speeds and brake cylinder pressures during a braking process.

The system is intended to be controlled by means of a slip controller. Since the manipulated variable yᵢ of the controller exerts influence on the brake system of the rail vehicle, the brake cylinder pressure p_{c,i} is a function πᵢ(yᵢ) of the controller manipulated variable yᵢ:

p_{c,i}=1·πᵢ(yᵢ). (13)

It is assumed that the brake system with the antiskid device has a transmission factor of 1 between the manipulated variable yᵢ and the brake cylinder pressure P_{c,i}.

For a selected brake state factor ξ′, i.e. for a specific rail vehicle type or general

$${ξ}^{′} = 1 \frac{m}{{s}^{2} P a} ,$$

a reference controller is to be designed preferably using methods of the robust controller design in order, for example, to obtain robustness of the control with respect to changing adhesion conditions in the wheel/rail contact and with respect to changes in the behavior in the pressure build-up in the brake cylinders over time. The control algorithm which is acquired in this way will have, with respect to its operating point, the following form

yᵢ=K′_{R,l}·ρᵢ(s_{setp,i}−sᵢ) for ξ (14)

Here, K′_{R,i} is the transmission factor of the controller of the i-th axle and ρᵢ is a function which is suitably selected in terms of the control objective and is dependent on the control deviation s_{setp,i}−sᵢ.

The adaptation of the controller transmission factor for another series of rail vehicles with a brake state factor ξ which is different from ξ′ but has the same or relatively high natural frequencies of the vehicle dynamics is carried out as per equation (1) by multiplying the controller transmission factor K′_{R,i} by the quotient of the brake state factors

$$\frac{{ξ}^{′}}{ξ} .$$

### The adapted control algorithm is therefore as follows

$${y}_{i} = {K}_{R , i} \cdot {ρ}_{i} ( {s}_{set p , i} - {s}_{i} ) with {K}_{R , i} = {K}_{R , i}^{′} \frac{{ξ}^{′}}{ξ} . \qquad ( 15 )$$

If, instead of a slip control, a skidding speed control is considered, the same relationship applies to the adaptation of the controller transmission factor. The skidding speed is defined as

ν_{G,i}=ν−Rωᵢ. (16)

If this relationship is used instead of equation (4), the following is obtained for the dynamics of the skidding speed:

$${\dot{v}}_{G , i} = - g ( \frac{1}{n} {\sum }_{i = 1}^{n} {f}_{x , i} ( {v}_{G , i} ) + \frac{1}{λ - 1} {f}_{x , i} ( {v}_{G , i } ) ) + \frac{λ}{λ - 1} {u}_{i} \qquad ( 17 )$$

and the control algorithm which is to be used as a reference has the following form in terms of its operating point:

yᵢ=K′_{R,i}·ρᵢ(ν_{G,setp,i}−ν_{G,i}) for ξ. (18)

The control algorithm which is adapted to the vehicle series is correspondingly

$${y}_{i} = {K}_{R , i} \cdot {ρ}_{i} ( {v}_{G , set p , i} - {v}_{G , i} ) with {K}_{R , i} = {K}_{R , i}^{′} \frac{{ξ}^{′}}{ξ} . \qquad ( 19 )$$

In the text which follows an explanation is given of how the brake state factor ξ can be determined by means of a braking process. It necessary to ensure that the braking process takes place on a track which is as level and straight as possible and that none of the n axles becomes unstable during the braking process. If these requirements are met, it is assumed below that approximately the same adhesion fₓ is present at all n axles, and approximately the same braking torque T_{B,i} is applied (identical or very similar pneumatic brake equipment at all n axles). The movement equations (2) and (3) of the n-th vehicle model are simplified to produce

$$\begin{matrix}\dot{v} = - {gf}_{x} & ( 20 ) \\ {\dot{ω}}_{i} = \frac{1}{{I}_{ω}} [ {Rf}_{x} \frac{M}{n} g - {T}_{B , i} ] , i = 1 , … , n . & ( 21 )\end{matrix}$$

Equation (20) can be reordered according to fₓ and the following is obtained with the approximation ν≈Rωᵢ with slow deceleration or low slip:

$${f}_{x} = - \frac{R {\dot{ω}}_{i}}{g} . \qquad ( 22 )$$

Inserting equation (22) into equation (21) provides

$$( 1 + \frac{{MR}^{2}}{{I}_{ω} n} ) {\dot{ω}}_{i} = - \frac{1}{{I}_{ω}} {T}_{B , i} . \qquad ( 23 )$$

Using the rotation factor λ from equation (7), equation (23) becomes:

$$\begin{matrix}{\dot{ω}}_{i} = - \frac{1}{R} \frac{n}{λ MR} {T}_{B , i} & ( 24 ) \\ = - \frac{1}{R} ξ {p}_{c , i} . & ( 25 )\end{matrix}$$

Resolving equation (25) according to the brake state factor ξ yields:

$$ξ = - \frac{R {\dot{ω} }_{i}}{{p}_{c , i}} . \qquad ( 26 )$$

In this way, a computation rule for determining the brake state factor ξ is obtained. If axle speeds are measured at q axles and brake cylinder pressures are sensed at l axles, the measured values should preferably be averaged over the axles. In this way an extended computational rule for determining the brake state factor ξ is obtained as follows:

$$ξ = - R \frac{\frac{1}{q} {\sum }_{i = 1}^{q} {\dot{ω}}_{i}}{\frac{1}{l} {\sum }_{i = 1}^{l} {p}_{c , i}} . \qquad ( 27 )$$

If the brake state factor is calculated as per equation (27) at various times k where k=1, . . . , m in the steady state phase of the braking process, it is recommended to finally average these values ξ(k)

$$\overline{ξ} = \frac{1}{m} {\sum }_{k = 1}^{m} ξ ( k ) . \qquad ( 28 )$$

According to equation (12), the brake state factor ξ is composed of a plurality of vehicle-specific parameters. These parameters can change over the operating period of a rail vehicle. For example, brake linings become worn etc. It is therefore recommended to adapt the controller transmission factor according to equation (1) from time to time for one and the same rail vehicle.

In some types of rail vehicle, the mass of the vehicle is determined during operation. Since the brake state factor ξ according to equation (12) depends on the rail vehicle mass, the information relating to the instantaneous mass can be utilized to refine the adaptation rule (1) by including the mass:

$${K}_{R , i} = {K}_{R , i}^{′} \frac{{ξ}^{′}}{ξ} \frac{M}{{M}_{0}} . \qquad ( 29 )$$

Here, M is the instantaneous mass of the rail vehicle and M₀ is the mass which the rail vehicle had at the time of the braking process for determining ξ.

FIG. 5a then shows the functional diagram of the “wheel set i” controlled system. The controlled system, which is illustrated as a transmission element between the braking torque T_{B,i} (input variable) and the slip sᵢ (output variable), can be regarded as a series connection of a “wheel/rail dynamics” transmission element 4 and a proportional element 5. The “wheel/rail dynamics” transmission element 4 describes the transmission behavior between the input variable uᵢ and the slip sᵢ and is described in the n-th vehicle model by the two differential equations (2) and (8). The proportional element 5 is represented by equation (9).

FIG. 5b shows the functional diagram of the “wheel set i with brake system” controlled system. The input variable of the controlled system is the brake cylinder pressure p_{c,i}. The proportional element connected upstream of the “wheel/rail dynamics” transmission element 4 thus has the transmission factor ξ as per equations (11) and (12). The transmission factor ξ is also referred to as the brake state factor.

FIG. 6a shows the “wheel set i with brake system” controlled system of a reference rail vehicle 7, now embedded in a closed control circuit for controlling the slip sᵢ with respect to the guide variable \dot{s}_{setp,i}. A reference controller 10 with the transmission factor K′_{R,i} has been configured for the wheel/rail dynamics 7 of the reference rail vehicle with the brake state factor ξ′ (reference number 8). The relationship between the manipulated variable yᵢ and the brake cylinder pressure p_{c,i}, is represented by the transmission block 9 (brake cylinder with antiskid valves of the reference vehicle).

FIG. 6b shows the control circuit with the “wheel set i with brake system” controlled system of a rail vehicle with the brake state factor ξ (reference number 6) for which the controller is to be adapted. The adapted controller 12 has the transmission factor as per equation (15). The brake cylinder with antiskid valves is provided with the reference number 11, 4 denotes the wheel/rail dynamics of the vehicle.

FIG. 7 is a diagram with measured values of the four wheel circumferential speeds Rω₁, Rω₂, Rω₃ and Rω₄ as well as the two brake cylinder pressures per bogie p_{c,1&2} and p_{c,3&4}. The values have been measured on a real rail vehicle. The lower plot shows the value of the brake state factor ξ, calculated from the measured values in the time range of the steady state braking process as per equations (27) and (28). The following is obtained for the mean value:

$$\overline{ξ} = 0.46 \frac{m}{{s}^{2} bar} .$$

FIG. 8 shows, by means of an exemplary embodiment, how the method according to the invention can be applied in a four-axle rail vehicle. The brake cylinder 15 generates braking force which acts on the brake disk 14 via the brake linkage with brake linings 16. As a result a braking torque which acts on the wheel set 13 is produced. The brake cylinder pressure results from the brake control pressure, which is applied to the brake cylinder 15 via the brake line 17 and the antiskid valves 18. A pressure sensor 19 makes measured values of the brake cylinder pressure available to the antiskid controller 21 (corresponds to the control system SYS in FIG. 1). Furthermore, the antiskid controller 21 receives measured values for the axle speed via the pulse generator 20. The antiskid controller 21 sets the antiskid valves 18. The antiskid controller 21 is a conventional controller with the transmission factor 22. By means of the unit for calculating the brake state factor 23, the value ξ is determined as per equation (28) and is used for updating the controller transmission factor 22 with respect to the given types of rail vehicle. The unit 23 for calculating the brake state factor requires measured values of the axle speeds and brake cylinder pressures of all four axles which have been assumed during the steady state phase of a stable braking process.

1.-18. (canceled)

19. A method for adapting a brake cylinder pressure of a pneumatic brake of a rail vehicle, which comprises the steps of:
during a braking process, performing the further steps of:
determining an instantaneous actual slip between at least one wheel of the rail vehicle and a rail;
predefining a setpoint slip between the at least one wheel and the rail;
determining a setpoint brake cylinder pressure in accordance with a deviation of the instantaneous actual slip from the predefined setpoint slip; and
measuring and adapting a current actual brake cylinder pressure to the setpoint brake cylinder pressure such that the deviation between the setpoint slip and the instantaneous actual slip approaches zero or is minimized.

20. The method according to claim 19, which further comprises predefining a permanently set value for the setpoint slip.

21. The method according to claim 19, which further comprises predefining a value for the setpoint slip in a variable fashion.

22. The method according to claim 21, which further comprises determining the setpoint slip within a scope of an optimum slip search.

23. The method according to claim 19, which further comprises selecting the setpoint slip in a region of a microslip.

24. The method according to claim 19, which further comprises selecting the setpoint slip in a region of a macroslip.

25. The method according to claim 19, which further comprises measuring the instantaneous actual slip continuously during an entire braking process.

26. A control system, comprising:
a slip controller for determining a setpoint brake cylinder pressure for adapting a current slip to a predefinable setpoint slip; and
a brake cylinder pressure controller for adapting a current brake cylinder pressure to the setpoint brake cylinder pressure determined.

27. The control system according to claim 26, further comprising a unit for determining an optimum value for the predefinable setpoint slip and disposed upstream of said slip controller.

28. A method for adapting a transmission factor of a slip controller from a reference vehicle to another vehicle, which comprises the steps of:
after a brake state factor of the other vehicle has been determined, calculating the transmission factor in accordance with relationship:
$${K}_{R , i} = {K}_{R , i}^{′} \frac{{ξ}^{′}}{ξ} ,$$
where K′_{R,i} is a known controller transmission factor of the reference vehicle and ξ′ is the brake state factor of the reference vehicle, and the brake state factor ξ′ is known or determined.

29. The method according to claim 28, which further comprises using the following relationship when a current measured value for a total vehicle mass is present:
$${K}_{R , i} = {K}_{R , i}^{′} \frac{{ξ}^{′}}{ξ} \frac{M}{{M}_{0}} ,$$
where M is a current rail vehicle mass and M₀ is a mass which the rail vehicle has during a determination of the brake state factor ξ.

30. A method for determining a brake state factor, which comprises the steps of:
during a stable braking process on a generally level and straight rail, continuously measuring an axle speed ωᵢ and a brake cylinder pressure p_{c,i} of a wheel set resulting in measured values; and
determining a brake state factor ξ from the measured values in accordance with the following relationship:
$$ξ = - \frac{R {\dot{ω} }_{i}}{{p}_{C , i}} .$$

31. The method according to claim 30, which further comprises using exclusively the measured values measured during the stable braking process.

32. The method according to claim 30, wherein, when axle speeds are measured at q axles and brake cylinder pressures at/axles, the following relationship is used to determine the brake state factor:
$$ξ = - R \frac{\frac{1}{q} {\sum }_{i = 1}^{q} {\dot{ω}}_{i}}{\frac{1}{l} {\sum }_{i = 1}^{l} {p}_{C , i}} .$$

33. The method according to claim 30, which further comprises:
recording at m different times the measured values;
determining brake state factors ξ(k) associated with the different times; and
mean values are formed for the brake state factors ξ(k) following:
$$\overline{ξ} = \frac{1}{m} {\sum }_{k = 1}^{m} ξ ( k ) .$$
